(19) United States
(12) Patent Application Publication
(10) Pub. No.: US 2013/0305790 A1
(43) Pub. Date: Nov. 21, 2013

(54) Skateboard Lock and Sling

(71) Applicants: Kevin James Seele, El Cajon, CA (US); Rory Hofstatter, El Cajon, CA (US)

(72) Inventors: Kevin James Seele, El Cajon, CA (US); Rory Hofstatter, El Cajon, CA (US)

(21) Appl. No.: 13/896,241

(22) Filed: May 16, 2013

Related U.S. Application Data
(60) Provisional application No. 61/647,922, filed on May 16, 2012.

(51) Int. Cl. E05B 73/00

(52) U.S. Cl. CPC E05B 73/0094
USPC 70/58

(57) ABSTRACT

A combination sling and locking component for employment in combination with a skateboard is provided. A housing having an internal cavity for a reeled cable is configured for operative sandwiched engagement between a skateboard deck and truck using fasteners through apertures in the housing aligned with existing passages in both the truck and deck which align. The cable is extendable to encircle an object and lock to the housing or to form a sling when just locked to the housing. A second mode of the device employs a second housing to provide the receiver for locking the end of the cable to a housing which provides a more elongated sling.

### FIELD OF THE INVENTION

This application claims priority to U.S. Provisional Patent Application Ser. No. 61/647,922, with a filing date of May 16, 2012 and is included herein in its entirety by this reference thereto.

The disclosed device is in the field of skateboards. More particularly, the disclosed device pertains to the field of skateboard security and transport when not ridden, through the provision of a cabled skateboard lock configured with apertures to act as a riser for a wheel truck. The device can also be configured to provide a sling for the user to carry the skateboard and can include a disturbance alarm which sounds only if an attempt is made to abscond with the board when in a cabled locked engagement around or to a stationary object.

### BACKGROUND OF THE INVENTION

A modern skateboard has evolved from its origins as a separated roller skate nailed to a board, to a high tech type of sports equipment. Employed for the activity of skateboarding, skateboards generally consist of a specially designed deck formed of one or a combination of wood, metal, and plastic and is generally afforded a polymer coating for making the exterior surface smooth. A smooth coated exterior ensures smoother slides and stronger durability of the deck.

The decks of skateboards vary in size but most are about 7 to 10.5 inches wide and generally between 28 and 33 inches long.

Attached to the lower surface of the skateboard deck are two metal trucks which provide a rolling engagement to wheels supporting the deck on the riding surface.

Most trucks are formed of at least two parts. An upper part of the truck which is fastened to the deck or a riser plate, is called the baseplate, and engaged beneath it for engagement to the wheels with an axle is the hanger.

Such skateboard trucks are manufactured in a number of different axle widths. However, by convention, there are only a few bolt patterns for engagement of the truck to the deck or the riser. Also, many skateboards will have a spacing plate or riser sandwiched between the baseplate of the truck and the bottom of the deck. Risers are used to increase the space between the truck and the deck which allows the truck to twist further without causing wheels to contact the surface of the deck in hard turns. Risers are also used for shock absorption and for increasing deck spring amongst other reasons. Generally, risers have the same bolt pattern for engagement to the deck as the trucks which allows four bolts and nuts to engage the truck and riser and deck together.

As can be discerned, because skateboards have evolved to high tech sports equipment, the cost of the differing parts forming the board, and the resulting board itself, can be hundreds and sometimes thousands of dollars. Additionally riders tend to become attached to their personal skateboard since they become used to its performance characteristics when riding and doing tricks.

Consequently, protecting a skateboard from intentional theft where a person intentionally absconds with a board, or accidental loss where a person may mistake a board for their own, and leave with it, is becoming ever more important. Very few riders have insurance for loss and even fewer can afford to purchase a replacement for a stolen skateboard which they may have built and paid for piece by piece over a long duration of time.

Further, during riding a skateboard is propelled by pushing with one foot while the other remains on the board, or by pumping one's legs in structures such as a pool or half pipe. A skateboard can also be used by simply standing on the deck while on a downward slope and allowing gravity to propel the board and rider. So the storage and transport of a skateboard when riding it is not an issue.

However, when entering a business such as a theater or arcade or other venue where skateboards are prohibited, a rider must somehow secure their board against accidental or intentional loss. This is an ever present problem for riders since absent the availability of a locker or garage or secure storage area at a visited venue prohibiting skateboards, there is no real way to secure the skateboard until it is to be ridden again.

Further, when in an area where riding the skateboard is not opportune, such as walking up a steep hill, or walking on the beach where sand would ruin the bearings, or when walking with a person who does not have a skateboard, the rider must hold onto the ungainly skateboard while carrying it. This can strain the hands over time, and bruise the shoulder if carried thereover, and is just plain troublesome.

As such, their exists an unmet need, for a device and method for securing a skateboard from accidental or intentional theft, when it is left unattended at a distance from the rider. Such a device ideally should be engaged with the skateboard itself, so as to always be available when needed. However, such a device should be compact enough when not in use, so as not to interfere with riding on a surface or doing tricks. Still further, such a device should ideally provide a solution to the problem of carrying the skateboard when it cannot or is not being ridden. Finally, such a device should be available with an audible or remote alarm system which alerts the owner when someone has attempted to remove the locked skateboard from its mooring by force, but does not set off the alarm when the skateboard is simply tumbled as occurs on occasion.

In this respect, before explaining at least one embodiment of the herein disclosed skateboard lock with alarm and carrying strap configuration, it is to be understood that the invention herein is not limited in its application to the details of construction and to the arrangement of the components set forth in the following description or illustrated in the drawings nor the steps outlined in the specification. The disclosed skateboard locking and sling device is capable of other embodiments and of being practiced and carried out in various ways as those skilled in the art will readily ascertain once educated in the novel device and method of this application.

Also, it is to be understood that the phraseology and terminology employed herein are for the purpose of description and should not be regarded as limiting in any manner. As such, those skilled in the art will appreciate that the conception upon which this disclosure of a skateboard lock with sling and alarm options is based, may readily be utilized as a basis for designing other methods and systems for carrying out the several purposes of the disclosed device herein. It is important, therefore, that the claims be regarded as including such equivalent construction insofar as they do not depart from the spirit and scope of the present invention.

### SUMMARY OF THE INVENTION

The device herein disclosed and described provides a solution to the noted shortcomings in prior art in skateboard locking and carrying devices through the provision of a skateboard lock configured for a sandwiched engagement between one or both skateboard trucks and the skateboard deck.

The securement of the device between the truck and the deck is accomplished using the conventional fasteners employed to secure the truck to the deck or to a riser. However, it may as an option be provided with nuts and/or bolts which require a special tool to remove to increase the security of the device if the rider feels it could be left alone for long periods where tools might be present.

In one mode of the device, the lock housing is formed to substitute for a riser between a single skateboard truck and the skateboard deck in a sandwiched engagement. In this first mode the lock housing is configured with passages communicating therethrough in registered positions to match the apertures employed on the truck and the deck for fastened engagement. Two sets of apertures at the correct spacings may be formed to allow for two types of bolt spacings.

Engaged securely between the deck and the truck, by fasteners such as bolts and nuts, the lock housing functions as the riser for the truck, but also provides for storage and deployment of a wound cable employed to secure the skateboard to an object such as a utility pole or lamp post. Within the lock housing is an elongated flexible member in the form of a metal cable having a first end secured to a reel, and a distal end projecting from the housing sufficiently to be grabbed by opposing thumb and finger.

In operation to engage the skateboard to a pole, the cable is pulled from a biased wound engagement on the reel, and extends from the housing a distance sufficient to circumvent a pole or object. Once around the object, the distal end of the cable is engageable with a point on the lock housing configured to lock in a secured engagement, to a fitting on the distal end of the cable. In this secured engagement, the cable extends from the lock housing around the object and is secured at its distal end to the lock housing. Thus, the skateboard is tethered to the object or pole or the like, which the cable encircles and the skateboard cannot be removed from the proximity of the object or pole, until the distal end is unlocked from an engagement point to the lock housing.

Because cables can appear less than secure, in one mode of the device an alarm is provided. The alarm is audible or may be wirelessly connected to a phone or computer in proximity to the skateboard. However, because skateboards can tend to be piled on each other or stacked when stored or locked to the same pole, it has been found that the alarm must resist going to a sonic or wireless alert if the skateboard is simply jostled by other boards stacked on it or other skateboards next to it being removed.

Consequently in a preferred mode, the device herein has an alarm which employs movement of the cable reel as a trigger for the alarm. This is because moving the board slightly or bumping the skateboard occurs often when it is secured and unsecured. By employing an alarm requiring movement of the winding reel for the cable to switch to alert mode, such false alarms are eliminated. In the preferred mode of the alarm, a trigger such as a movement sensor or a mechanical movement sensor communicates perceived movement of the cable reel to the alarm component which is interpreted as a trigger which sounds the alarm or broadcasts an alert to a cell phone or the like. However, bumping or tilting the board as happens from other skateboards will not trip the alarm.

In another mode of the device herein, a two-housing configuration is employed. A lock housing is placed in a sandwiched engagement between a first truck and the deck, and a secondary or cable housing holding the cable and reel is placed in a sandwiched engagement between the other of the trucks and deck. In this configuration, the cable extends from the secondary housing when unreeled, and is engaged to a locking point on the first or lock housing. Release occurs in the same fashion where the user unlocks the lock securing the cable to the lock casing.

The alarm device in this mode may be placed in either housing and is preferably enabled with the delay from triggering unless the cable is translated, which would occur when the skateboard locked to an object, is pulled.

In both modes of the device, the locked cable is employable as a sling to carry the skateboard by engaging the cable over the shoulder or arm or bicycle or other mount for carrying. The mode of the device with first and second housings deploys the cable in a linear fashion to a lock, and thus is preferred for over the shoulder or arm use as a sling.

All modes of the device provide one or two sets of apertures formed in the housing which will align with the apertures conventionally used on trucks and decks and risers.

With respect to the above description, before explaining at least one preferred embodiment of the herein disclosed skateboard lock and sling device invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other skateboard locks with slings for carrying out the several purposes of the present disclosed device. It is important, therefore, that the claims be regarded as including such equivalent construction and methodology insofar as they do not depart from the spirit and scope of the present invention.

Still further, as used in the claims to describe the various inventive aspects and embodiments of the invention, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of this invention to provide a skateboard lock which engages the skateboard to be available for use.

It is another object of the present invention to provide such an engaged skateboard lock, which when not in use will not substantially affect the ability of the skateboard to do tricks.

A still further object of this invention is to provide such a skateboard lock, which also doubles as a sling to support the skateboard on the user's body or another device such as a bicycle when the skateboard is in transit with the rider.

Yet another object to concurrently provide a skateboard lock which doubles as a sling, and which is enabled with an alarm which triggers only if an attempt to stretch or break the securing cable is attempted.

These and other objects features, and advantages of the present skateboard locking invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some but not the only or exclusive, examples of skateboard locks and slings for the transport thereof. It is intended that the embodiments and figures disclosed herein are to be considered illustrative of the invention herein, rather than limiting. In the drawings:

FIG. 1 depicts a mode of the device employing a single cable housing for both reeling and locating the distal end of the cable to the skateboard.

FIG. 2 shows a view of the skateboard housing of FIG. 1, showing the locking component adjacent a locking port, and showing the plurality of apertures positioned to match such in the truck and deck.

FIG. 3 depicts an internal view of the reeled cable and locking port for locking a cable distal end therein by a keyed or displayed combination lock and the alarm configuration.

FIG. 4 shows a view of a bottom of a skateboard having a first hosing for the cable reel and second housing for the lock and locking point for the cable distal end and showing the cable prepared for use as sling or to be secured around an object.

FIG. 5 depicts a mode of the device of FIG. 4 showing the first housing with cable reel.

FIG. 6 depicts the mode of the device shown in FIG. 4 and showing a second housing adapted to function as a riser and having the engagement point for locking the distal end of the cable.

### DETAILED DESCRIPTION OF THE INVENTION

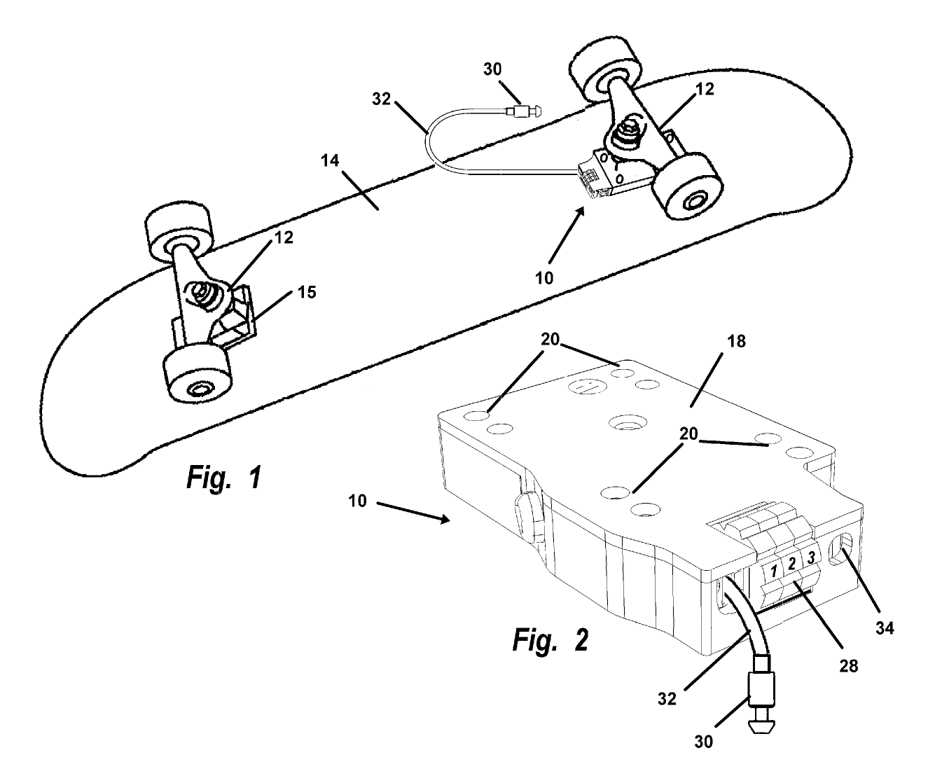

Now referring to drawings in FIGS. 1-5, wherein similar components are identified by like reference numerals, there is seen in FIG. 1, the device 10 in an as-used position in a sandwiched engagement, secured between the truck 12 and the deck 14. Securement is accomplished using fasteners 16 which may be the conventional nut and bolt fasteners employed to secure the truck 12 to the deck 14 or to a riser 15. However, for extra security where the device 10 may be left for long occasions and thieves with tools are a worry, nuts and/or bolts which require a special tool such as those with unconventional heads, or recessed engagement points, may be provided to increase the security of the device 10. Any such fastener as one skilled in the art would find in the 2013 GRANGER catalog fastener section is anticipated within the scope of fasteners employed herewith.

In one mode of the device 10, a first housing or lock housing 18 is formed to engage in a sandwiched engagement between a truck 12 and the deck 14. In this first mode the lock housing 18 is configured with apertures 20 communicating therethrough in registered patterns to match the patterns of apertures employed on the truck 12 and the deck 14. Two sets of apertures 20 as seen in FIGS. 2, 5, and 6, at the correct spacings are preferred.

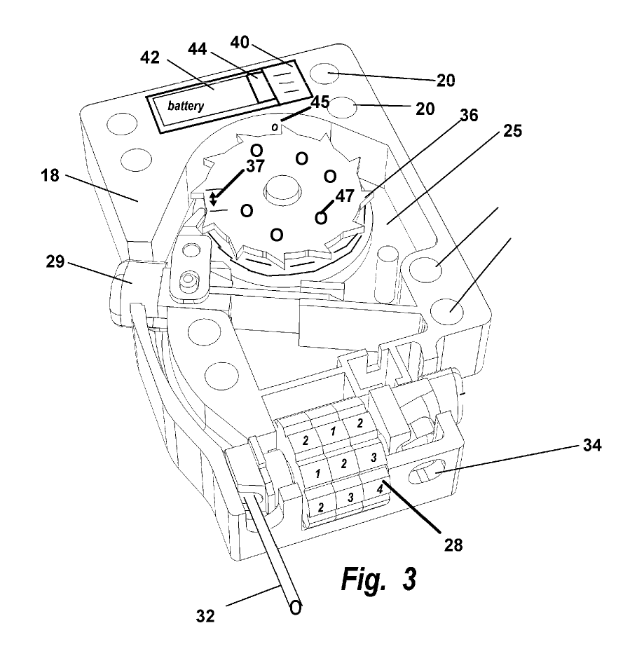

The first or lock housing 18 may function as the riser 15 for the truck 12 where it is engaged with the deck 14. An internal cavity 25 (FIG. 3) the lock housing 18 operatively positions a lock 28 which may be keyed or combination, for access by the user to unlock the distal end 30 of the cable 32 from its engagement with the lock seat 34 controlled by the lock 28.

In the mode of the device where the cable 32 is stored in combination with the lock 28 and seat 34, the cable 30 is wound onto a reel 36 which is preferably spring loaded to rewind when pulled to a point of unwind, so as to automatically rewind the release 29 is pushed to allow the cable 32 to rewind back on the reel 36. The distal end 30 of the cable 32 has a fitting thereon formed for cooperative locked engagement into the lock seat 34 until released by an unlocking of the lock 28 by key or combination.

Within the lock housing 18 or a second housing 19 in the two-housing mode, an elongated flexible member in the form of a metal cable 32 has a first end secured to reel 36 so it will not dismount. The distal end 30 projects from the housing 18 or 19 sufficiently to be grabbed by the user and pulled to unwind from the reel 36 and if spring loaded (not shown) as preferred, to impart force to the rewind spring to retract the cable 32 back wound on the reel 36 when not in use.

In a secured engagement, the cable extends from the lock housing 18 or second housing 19 and a stationary object such as a pole, and the distal end 30 of the cable 32 is locked into the lock seat 34 until released by unlocking the lock 28.

An alarm 40 may be provided which would be battery 42 powered and will have a trigger 44 to render an audible or broadcast a wireless alarm to be received by the user in reasonable proximity to the skateboard, and heard by bystanders. Preferably the trigger 44 is not activated by simple movement of the skateboard to avoid false alarms but instead is activated by a pulling or yanking of the skateboard when secured by the cable 32. In the current mode, a pulling on a secured cable 32 will cause a slight rotation 37 distance of the reel 36 which may be ascertained by a triggering component 45 such as a magnetic pickup 45 which senses a field projected by one or a plurality of magnets 47 on the reel 36. Thus only a pull or tug on the board, (in a stealing action) will rotate the reel 36 and trigger the alarm 40 to sound or broadcast a wireless alert or both.

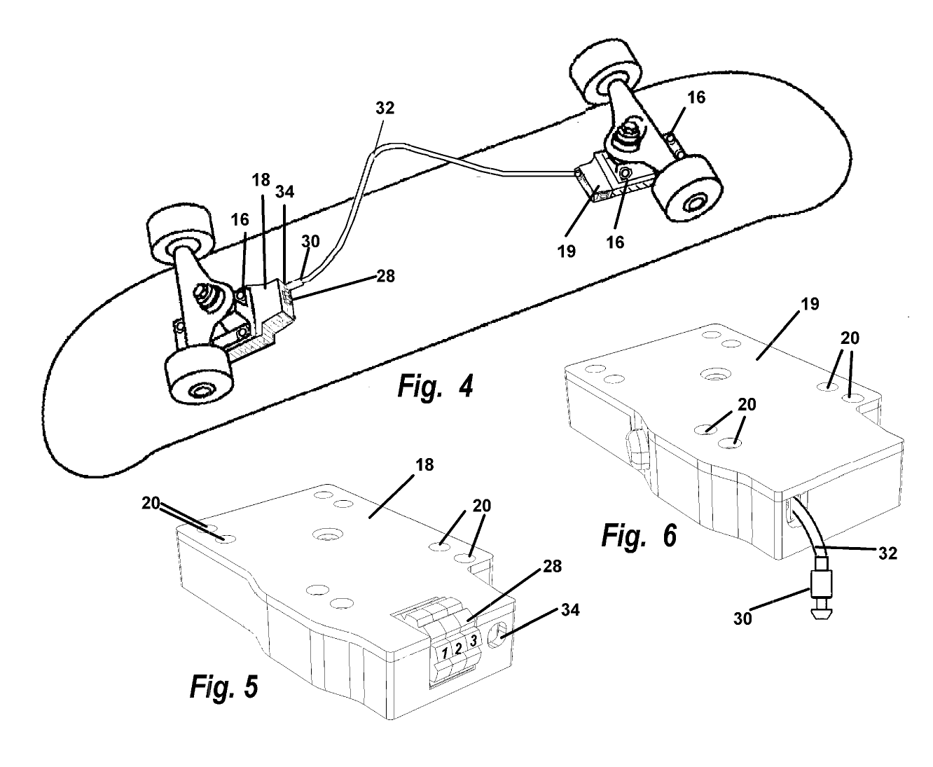

In another preferred mode of the device 10 herein, a two-housing configuration is employed as seen in FIGS. 4-6. A first housing or lock housing 18 is placed in a sandwiched engagement between a first truck 12 and the deck 14, and a secondary or cable housing 19 holding the cable 32 and reel 36 is placed in a sandwiched engagement between the other of the trucks 12 and deck 14. Engagement of the cable 32 is to the lock seat 34 as in the first mode, however the cable extends along the axis of the deck 34 which renders it similar to a shoulder strap for a carrying configuration of the device 10 when not locked around an object. The alarm 40 in this mode may be placed in either housing and is preferably enabled with the delay from triggering until the cable 32 is translated.

As noted, in modes of the device 10, the locked cable 32 is employable as a sling to carry the skateboard by engaging the cable over the shoulder or arm or bicycle or other mount for carrying.

As noted above, while the present invention has been described herein with reference to particular embodiments thereof and steps in the method of production, a latitude of modifications, various changes and substitutions are intended in the foregoing disclosures, it will be appreciated that in some instance some features or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A locking apparatus for use in combination with a skateboard, comprising:
a first housing having an internal cavity;
said first housing having a plurality of apertures communicating therethrough, said apertures in a registered positioning to align in-between aligned passages for mounting a skateboard truck upon a skateboard deck;
said housing fixedly engageable in a sandwiched engagement in-between a first said skateboard truck and a skateboard deck using fasteners communicating through said aligned passages and said apertures;
a cable, said cable having a first end engaged within said internal cavity;
a section of said cable extendable from within said internal cavity to a distal end at an end of said section opposite said first end of said cable;
a lock, said lock having a locked state securing said distal end in a locked engagement with said receiver, said lock having an unlocked state allowing removal of said distal end from said receiver; and
whereby with said first housing in a said sandwiched engagement said skateboard, said cable is positionable to a first position forming a sling, with said distal end engaged in said receiver, and said cable is positionable to a second position forming a locked engagement of said skateboard to an object, by a positioning of said section of cable in an encirclement of said object and a positioning of said distal end of said cable in said receiver with said lock in said locked state.

2. The locking apparatus of claim 1, additionally comprising:
a reel located in said cavity, said reel biased to rewind said section of said cable thereon when said distal end is disengaged from said receiver.

3. The locking apparatus of claim 1, additionally comprising:
said lock being one of a combination lock or keyed lock.

4. The locking apparatus of claim 2, additionally comprising:
said lock being one of a combination lock or keyed lock.

5. The locking apparatus of claim 2, additionally comprising:
an alarm engaged with said first housing;
a trigger for initiating said alarm to broadcast a sonic or wireless alarm; and
said trigger only actuated with said cable in said second position, by a translation of said cable sufficient to rotate said reel, whereby a pulling on said skateboard with said cable in said second position, a distance sufficient to initiate a rotation of said reel triggers said alarm, and movement of said skateboard without said rotation does not trigger said alarm.

6. The locking apparatus of claim 4, additionally comprising:
an alarm engaged with said first housing;
a trigger for initiating said alarm to broadcast a sonic or wireless alarm; and
said trigger only actuated with said cable in said second position, by a translation of said cable sufficient to rotate said reel, whereby a pulling on said skateboard with said cable in said second position, a distance sufficient to initiate a rotation of said reel triggers said alarm, and movement of said skateboard without said rotation does not trigger said alarm.

7. The locking apparatus of claim 1, additionally comprising:
a second said housing having an internal cavity;
said second housing having a plurality of said apertures communicating therethrough, said apertures in a said registered positioning to align in-between aligned passages of a skateboard truck and of a skateboard deck;
said second housing fixedly engageable in a sandwiched engagement in-between a second said skateboard truck and said skateboard deck using fasteners communicating through said aligned passages and said apertures;
said receiver and said lock located in said second housing;
said cable is positionable to said first position forming an elongated sling extending between said first housing and said second housing by engagement of said distal end of said cable in said receiver; and
said cable is positionable to said second position forming a locked engagement of said skateboard to an object, by a positioning of said section of cable in an encirclement of said object and a positioning of said distal end of said cable in said receiver in said second housing with said lock in said locked state.

8. The locking apparatus of claim 7, additionally comprising:
a reel located in said internal cavity of said first housing, said reel biased to rewind said section of said cable thereon when said distal end is disengaged from said receiver in said second housing.

9. The locking apparatus of claim 8, additionally comprising:
an alarm engaged with said first housing;
a trigger for initiating said alarm to broadcast a sonic or wireless alarm; and
said trigger only actuated with said cable in said second position, by a translation of said cable sufficient to rotate said reel, whereby a pulling on said skateboard with said cable in said second position, a distance sufficient to initiate a rotation of said reel, triggers said alarm, and movement of said skateboard without initiating a said rotation does not trigger said alarm.
